(19) United States
(12) Patent Application Publication
(10) Pub. No.: US 2026/0046839 A1
(43) Pub. Date: Feb. 12, 2026

(54) PAGING OPTIMIZATIONS FOR AMBIENT-POWERED INTERNET-OF-THINGS DEVICES

(71) Applicant: InterDigital Patent Holdings, Inc., Wilmington, DE (US)

(72) Inventors: Anuj Sethi, Ottawa (CA); Guanzhou Wang, Brossard (CA); Mohamad Kenan Al-Hares, Canterbury (GB); Michael Starsinic, Newtown, PA (US); Samir Ferdi, Kirkland (CA); Alec Brusilovsky, Downingtown, PA (US); Saad Ahmad, Montreal (CA)

(73) Assignee: InterDigital Patent Holdings, Inc., Wilmington, DE (US)

(21) Appl. No.: 18/798,538

(22) Filed: Aug. 8, 2024

(51) Int. Cl. H04W 68/02; H04W 4/12; H04W 24/02

(52) U.S. Cl. CPC H04W 68/02; H04W 4/12; H04W 24/02

(57) ABSTRACT

Methods, systems, and devices for an ambient powered internet-of-things (AIoT) device paging. In some implementations, a paging request message is received, and a response is transmitted to the paging request message based on a paging response configuration. In some implementations, a no-response time is started based on responding to the paging request message, wherein the AIoT device ignores further paging request messages until the no-response time has elapsed. In some implementations, a no-response time is started based on responding to the paging request message, wherein the AIoT device ignores further paging request messages that are of a particular type and does not ignore further paging requests that are not of the particular type, until the no-response time has elapsed.

### BACKGROUND

An ambient powered internet-of-things (AIoT) device is a kind of IoT device that is capable of harvesting energy from the environment, such as from wireless radio waves, motion, vibration, piezoelectricity, solar and wind power, etc., e.g., for powering the device. AIoT devices are either battery-less or have limited energy storage (e.g., using a capacitor). In some implementations, Ambient power-enabled IoT devices are used in Industrial Wireless Senor Networks where the environment is harsh (e.g., extremely high or low temperature) and/or which requires devices to be battery-less, maintenance-free and of long service life. In some implementations, AIoT devices are used in Smart Logistics and Smart Warehousing applications. In some implementations, such low-cost, small-form, battery-lessness and/or durability may have the advantage of making AIoT devices suitable to be attached to huge numbers of goods, and may facilitate more efficient goods identification, sorting, tracking and/or inventory. In some Ambient power-enabled IoT use cases, AIoT devices may be involved in very small sized data transmission and/or reception, such as in sending device identification, product information, and/or sensor data, or as in receiving actuator commands and/or triggering messages, and so forth.

### SUMMARY

Methods, systems, and devices for AIoT device paging. In some implementations, a paging request message is received, and a response is transmitted to the paging request message based on a paging response configuration. In some implementations, a no-response time is started based on responding to the paging request message, wherein the AIoT device ignores further paging request messages until the no-response time has elapsed. In some implementations, a no-response time is started based on responding to the paging request message, wherein the AIoT device ignores further paging request messages that are of a particular type and does not ignore further paging requests that are not of the particular type, until the no-response time has elapsed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example system where a network uses an intermediate node to locate and page an ambient energy powered device, such as an AIoT device;

FIG. 3 is a system diagram of an example network that illustrates an example enhanced 5GS architecture to support AIoT devices and services;

FIG. 4 is a message sequence chart illustrating an example procedure for paging AIoT devices, and for configuring AIoT devices for paging; and

FIG. 5 is a flow chart which illustrates an example method, implemented in an AIoT device, for handling a paging request message.

### DETAILED DESCRIPTION

Some implementations provide a method implemented in an ambient powered internet-of-things (AIoT) device. A paging request message is received, and a response is transmitted to the paging request message based on a paging response configuration.

In some implementations, a no-response time is started based on responding to the paging request message, wherein the AIoT device ignores further paging request messages until the no-response time has elapsed. In some implementations, a no-response time is started based on responding to the paging request message, wherein the AIoT device ignores further paging request messages that are of a particular type and does not ignore further paging requests that are not of the particular type, until the no-response time has elapsed. In some implementations, a no-response time is started based on responding to the paging request message, wherein the AIoT device ignores further all-device paging request messages and does not ignore further paging requests that are not all-device paging request messages, until the no-response time has elapsed. In some implementations, a no-response time is started based on responding to the paging request message, wherein the AIoT device ignores further paging request messages of a same type as the received paging request message and does not ignore further paging requests that are not of the same type as the received paging request message, until the no-response time has elapsed.

In some implementations, a no-response time is started based on responding to the paging request message, wherein the AIoT device ignores further paging request messages from a same sender from whom the received paging request message was received and does not ignore further paging requests that are not from the same sender, until the no-response time has elapsed. In some implementations, a no-response time is started when the paging request message is received, or when the response to the paging request message is transmitted. In some implementations, the response to the paging request message comprises a device identity (ID) of the AIoT device. In some implementations, the device ID comprises a true device ID of the AIoT device or an alternate device ID of the AIoT device, based on the paging response configuration. In some implementations, the AIoT device generates the alternate device ID based on an algorithm indicated by the paging response configuration.

Some implementations provide an ambient powered internet-of-things (AIoT) device. The AIoT device includes circuitry configured to receive a paging request message. The AIoT device also includes circuitry configured to transmit a response to the paging request message based on a paging response configuration.

In some implementations, the AIoT device includes circuitry configured to start a no-response time based on responding to the paging request message, wherein the AIoT device ignores further paging request messages until the no-response time has elapsed. In some implementations, the AIoT device includes circuitry configured to start a no-response time based on responding to the paging request message, wherein the AIoT device ignores further paging request messages that are of a particular type and does not ignore further paging requests that are not of the particular type, until the no-response time has elapsed. In some implementations, the AIoT device includes circuitry configured to start a no-response time based on responding to the paging request message, wherein the AIoT device ignores further all-device paging request messages and does not ignore further paging requests that are not all-device paging request messages, until the no-response time has elapsed. In some implementations, the AIoT device includes circuitry configured to start a no-response time based on responding to the paging request message, wherein the AIoT device ignores further paging request messages of a same type as the received paging request message and does not ignore further paging requests that are not of the same type as the received paging request message, until the no-response time has elapsed.

In some implementations, the AIoT device includes circuitry configured to start a no-response time based on responding to the paging request message, wherein the AIoT device ignores further paging request messages from a same sender from whom the received paging request message was received and does not ignore further paging requests that are not from the same sender, until the no-response time has elapsed. In some implementations, the AIoT device includes circuitry configured to start a no-response time when the paging request message is received, or when the response to the paging request message is transmitted. In some implementations, the response to the paging request message comprises a device identity (ID) of the AIoT device. In some implementations, the device ID comprises a true device ID of the AIoT device or an alternate device ID of the AIoT device, based on the paging response configuration. In some implementations, the AIoT device generates the alternate device ID based on an algorithm indicated by the paging response configuration.

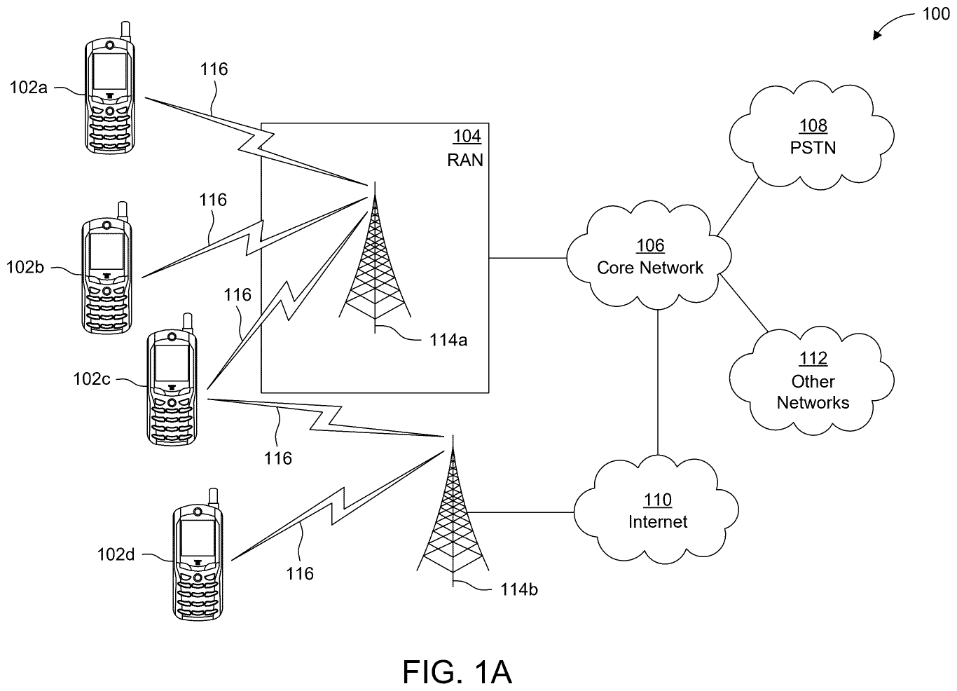

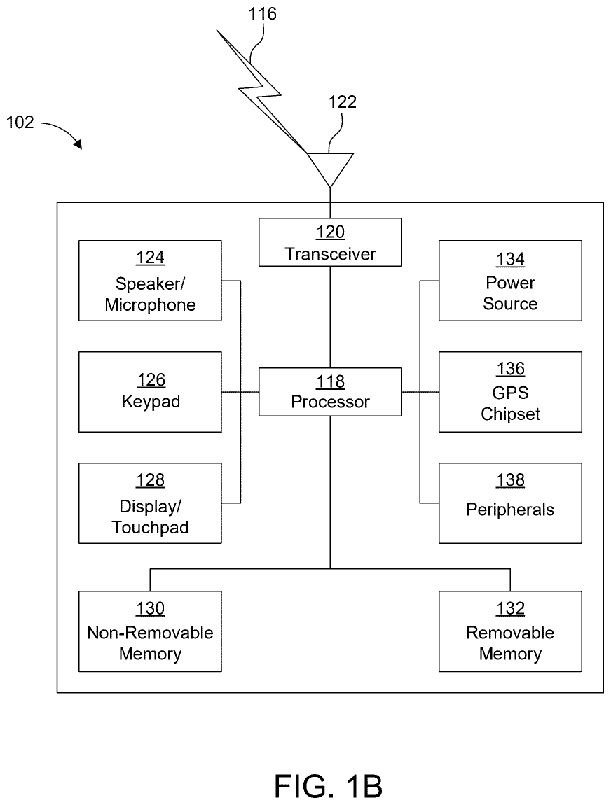

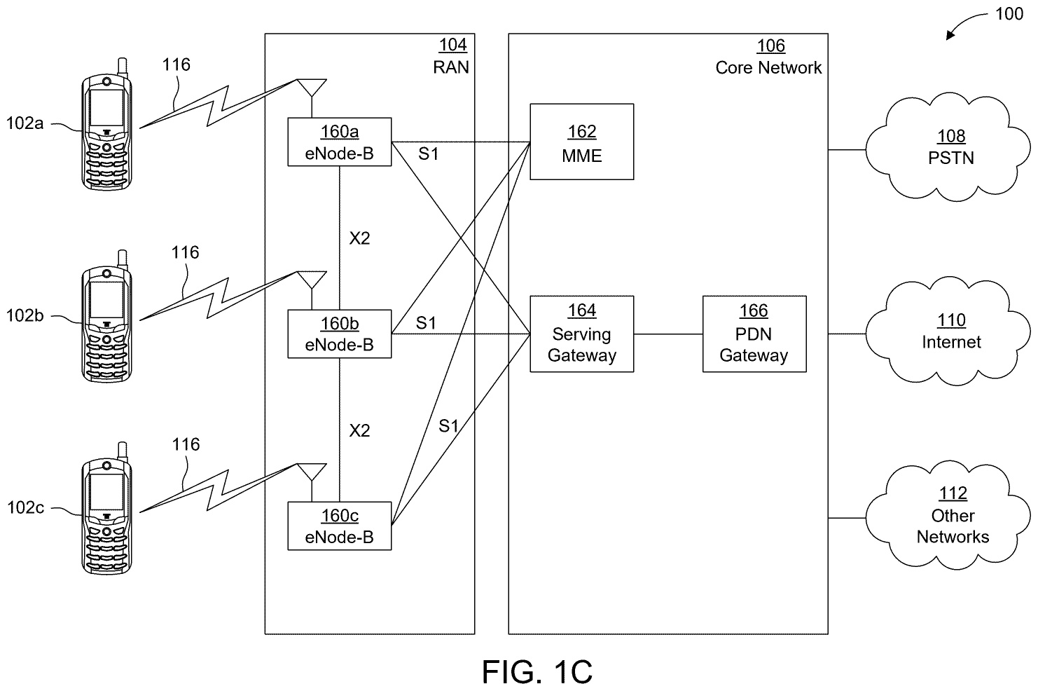

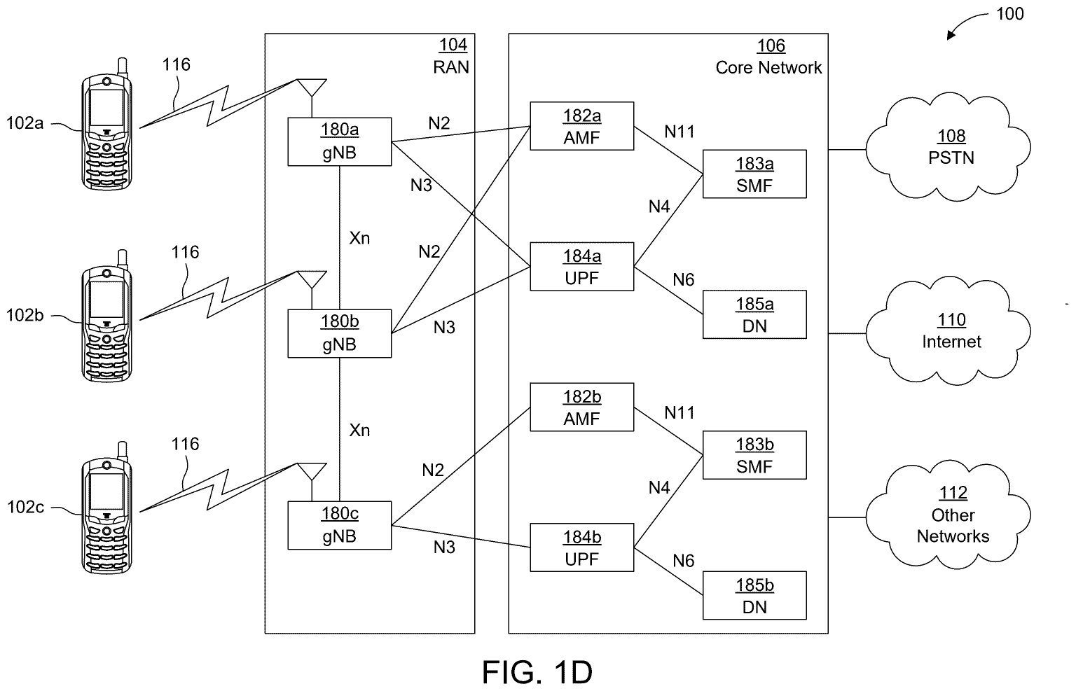

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### ABBREVIATIONS AND ACRONYMS

ADTC AIoT Data Transmission Context
AF Application Function
AIoT Ambient IoT device
AIoTF Ambient IoT Function
AMF Access and Mobility Function
A-RAN Ambient IoT RAN
CAG Closed Access Group
CIoT Cellular IoT
eHN equivalent Hosting Networks
EHPLMN Equivalent Home PLMN
eSNPN equivalent SNPNs
FPLMN Forbidden PLMN
GIN Group ID for Network Selection
GUI Graphical User Interface
HPLMN Home Public Land Mobile Network
IE Information Element
IMSI International Mobile Subscriber Identity
MCC Mobile Country Code
MNC Mobile Network Code
MS Mobile Station
NAS Non-Access Stratum
NG Next Generation
NPN Non-Public Network
NS Network Slicing
NSSAA Network Slice-Specific Authentication and Authorization
NSSAI Network Slice Selection Assistance Information
NWDAF Network Data Analytics Function
OPLMN Operator Controlled PLMN (Selector List)
PALS Providing Access to Localized Services
PLMN Public Land Mobile Network
PNI-NPN Public Network Integrated NPN
RA Random Access
RA Registration Area
RACH Random Access Channel
RAN Radio Access Network
RAT Radio Access Technology
RFSP RAT/Frequency Selection Priority
RPLMN Registered Public Land Mobile Network
SIM Subscriber Identity Module
SNPN Standalone NPN
S-NSSAI Single NSSAI
SoR Steering of Roaming
SoR-SNPN-SI-LS SoR SNPN Selection Information for Localized Services
TA Tracking Area
TAI TA Identity
UE User Equipment
UICC Universal Integrated Circuit Card
USIM UICC with SIM
VPLMN Visited Public Land Mobile Network

Some implementations include an Ambient IoT (AIoT) Device. In some implementations, an AIoT device is an IoT WTRU device that is powered by energy harvesting. In some implementations, the AIoT device has limited energy storage capability. In some implementations, some or all other characteristics of an AIoT device are as defined in 3GPP TR 38.769.

Some implementations include an AIoT reader. In some implementations, an AIoT reader is a WTRU device which communicates directly with an AIoT device. In some implementations, an AIoT reader provides an AIoT device with access to a 5G network (e.g. AMF), either directly or indirectly (e.g., indirectly by acting as an intermediate node between the AIoT device and a 5G base station). In some implementations, the AIoT reader includes a base station, node B (e.g., gNB), and/or other WTRU device. In some implementations, an AIoT reader is an intermediate WTRU device which communicates between the AIoT device and a network (e.g., 5G base station). The terms reader, intermediate WTRU, gNB, A-RAN, and base station are used interchangeably herein unless indicated otherwise.

Some implementations include AIoT paging. In the Access Stratum (AS) layer, AIoT paging functionality is used to indicate an AIoT device or devices that must respond to the paging. In some implementations, an AIoT paging message is sent to indicate an AIoT device or devices that must respond to the paging. In some implementations, the AIoT paging message is a trigger message. In some implementations, an identifier is used to identify an AIoT device or group of devices in the AIoT paging message (e.g., for the case of paging a single or a group of AIoT devices). In some implementations, no identifier being present in the paging message indicates that all AIoT devices that have received the paging should respond to the paging.

It is noted that in some implementations, inventory and paging are similar procedures (e.g., both are DL requests for an AIoT device to respond (e.g., with an identification). In some implementations, paging may not ask for additional information, whereas an inventory procedure may ask for additional information in response.) Accordingly, various examples herein described with respect to paging also apply to inventory, and various examples herein described with respect to inventory also apply to paging. The terms inventory request message, AIoT paging message, paging message, and initial trigger message are used interchangeably herein, unless indicated otherwise.

Some implementations include an AIoT random access (RA) procedure. In some implementations, the AIoT RA procedure is triggered by an AIoT reader. In some implementations AIoT RA is triggerable for a single AIoT device, group of AIoT devices, or all AIoT devices within the coverage of the reader.

Some implementations include an Ambient IoT Function (AIoTF). In some implementations, the AIoTF is a network function (e.g., a 5G network function) which supports AIoT services. In some implementations, the AIoTF is a standalone function. In some implementations, the AIoTF is collocated with the AMF. In some implementations, the AIoTF is responsible for authentication and authorization of the AIoT devices, routing of the UL/DL traffic between the AIoT devices and/or AF (via NEF).

In some implementations, an AIoTF is supports AIoT services. In some implementations, an AIoTF integrates AMF functionalities, such as one, some, or all of the following: A-RAN (Ambient IoT RAN) connectivity, inventory (Paging) handling and device context management, authentication and authorization for the access (e.g., which triggers interaction with AUSF/UDM), collection of charging data and/or interaction with CHF for charging, routing of the paging request from AF (e.g., via NEF) to A-RAN, for DO-DTT/DT traffic types, and/or routing of the response from A-RAN to AF (e.g., via NEF) for DO-DTT traffic type.

The term AIoT Services refers to functionalities and procedures which support AIoT use cases. The term device-terminated (DT) refers to a type of traffic which is terminated at the AIoT device. The term device-originated device-terminated triggered (DO-DTT) refers to a type of traffic where device originated traffic is triggered by device terminated traffic or signaling.

Random Access (RA) is a procedure that may be used by a device to gain initial access to a network after the device has had a period of inactivity. The concepts described herein can be applied to any procedure that is used by a device to gain access (e.g., initial access) to a network. In some implementations, an AIoT device initiates a RA (random access) procedure in response to detecting an AIoT Paging message or trigger that indicates that it may need to send information to the network.

The terms AIoT device, Ambient IoT device, Ambient-Powered IoT device, Ambient Power-Enabled IoT device, and WTRU are used interchangeably herein, unless indicated otherwise.

Some implementations include an AIoT Device performing a RACH procedure. In some implementations, an AIoT Device performs a RACH procedure by transmitting a random access message to the reader to attempt to access the network and the AIoT Device determines that the RACH procedure is successful if the AIoT Device has gained access to the network. In some implementations, the AIoT Device may determine whether or not a RACH is successful, based on receiving a message from the network. A broadcast message from a base station or reader is an example of an Access Stratum (AS) message.

Some implementations relate to AIoT devices, and use cases for AIoT devices. An AIoT device is a kind of IoT device that is capable of harvesting energy from the environment, such as wireless radio waves, motion, vibration, piezoelectricity, solar and wind power, etc., e.g., for powering the device. They are either battery-less or have limited energy storage (e.g., using a capacitor). In some implementations, Ambient power-enabled IoT devices are used in Industrial Wireless Senor Networks where the environment is harsh (e.g., extremely high or low temperature) and/or which requires devices to be battery-less, maintenance-free and of long service life. In some implementations, AIoT devices are used in Smart Logistics and Smart Warehousing applications. In some implementations, such low-cost, small-form, battery-lessness and/or durability may have the advantage of making AIoT devices suitable to be attached to huge numbers of goods, and may facilitate more efficient goods identification, sorting, tracking and/or inventory. In some Ambient power-enabled IoT use cases, AIoT devices may be involved in very small sized data transmission and/or reception, such as in sending device identification, product information, and/or sensor data, or as in receiving actuator commands and/or triggering messages, and so forth.

Various enhancements to 5G networks may be implemented to support AIoT devices and use cases. In some implementations it is assumed that AIoT devices do not support RRC states, nor mobility or handover. In some implementations, AIoT device types include DT (Device-terminated), DO-DTT (Device-originated—device-terminated triggered) and DO-A (Device-originated—autonomous). Some implementations have a BS-to-AIoT device topology. Some implementations have a BS-to-intermediate node-to-AIoT device topology.

AIoT devices may be implemented in different connectivity topologies. For example, in some implementations, AIoT devices may be implemented in base station (BS)-to-AIoT device topologies (referred to as Topology 1 herein), and/or BS-to-intermediate node-to-AIoT device topologies (referred to as Topology 2 herein). In other words, for Topology 1, the AIoT device communicates directly with the BS, and in Topology 2, the AIoT device communicates with the BS via an intermediate node.

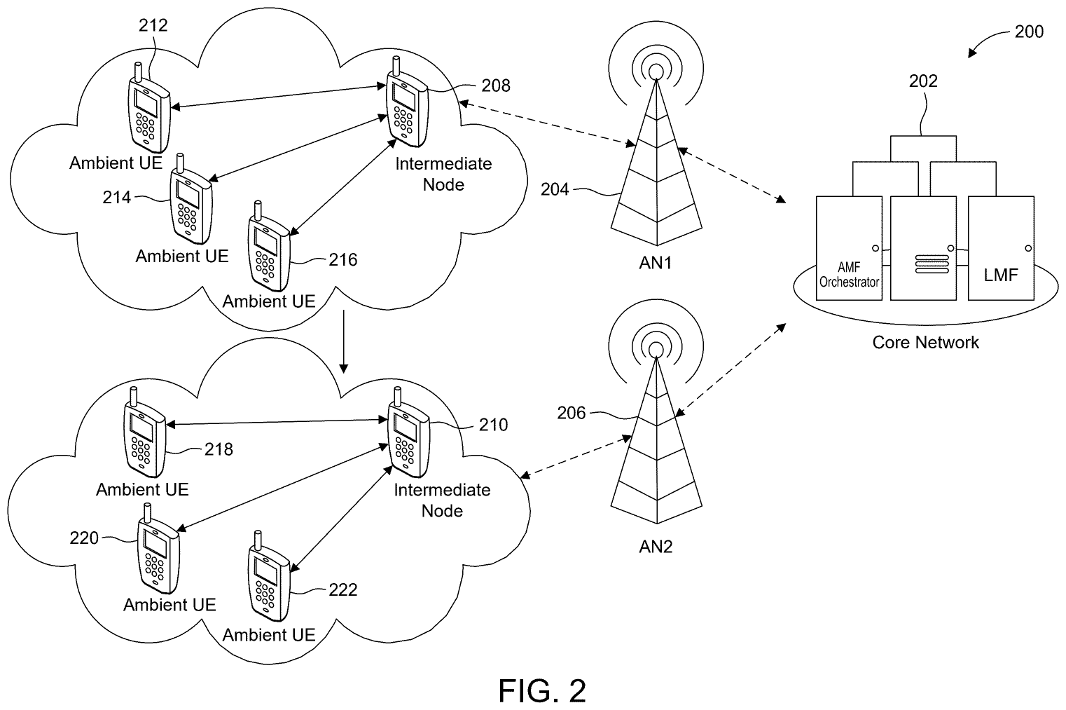

Some implementations include AIoT devices behind an intermediate node (i.e., in communication with a network, such as a base station, via an intermediate WTRU). FIG. 2 is a system diagram illustrating an example system 200 where a network uses an intermediate node to locate and page an ambient energy powered device, such as an AIoT device. It is noted that in some implementations, the network does not use an intermediate node. System 200 includes a core network (CN) 202, antennas/base stations 204, 206, intermediate nodes 208, 210, and AIoT devices 212, 214, 216, 218, 220, 222. In this example, intermediate nodes 208, 210 are non-ambient powered WTRUs, and AIoT devices 212, 214, 216, 218, 220, 222 are ambient-powered WTRUs, however, it is noted that any suitable intermediate nodes and AIoT devices are usable in other implementations.

In an example application, CN 202 network might use an intermediate node 208 to locate AIoT device, e.g., 212 due to the limited transmit power availability in AIoT device 212 and/or the possibility of IoT device 212 becoming deactivated if it runs out of power. In some implementations, if an AIoT device (e.g., AIoT device 212) becomes un-pageable (e.g., due to distance, lack of transmission power, and/or deactivation), the network (e.g., CN 202) may use an intermediate node (e.g., intermediate node 208) location to page the AIoT device (e.g., AIoT device 212). In some implementations, the network could consider the intermediate node (e.g., intermediate node 208) location as the location of the AIoT device (e.g., AIoT device 212), or to infer the location of the AIoT device.

In some implementations, AIoT devices may send and receive different kinds of traffic (e.g., control and data). For example, in some implementations, AIoT devices may send and/or receive Device-Terminated (DT) traffic and/or Device-Originated-Device-Terminated Triggered (DO-DTT) traffic.

In some implementations the communication spectrum on which the AIoT device operates is assumed to be licensed, however, in other implementations, the communication spectrum is unlicensed. In some implementations handover is not supported, however in other implementations handover is supported. In some implementations RRC states are not supported by AIoT devices, however in other implementations RRC states are supported. In some implementations mobility is not supported by AIoT devices, however in other implementations mobility is supported.

Some implementations include NR Paging. Paging and Service Request are mechanisms by which a network may alert a WTRU of incoming downlink data, and by which the WTRU may activate or reactivate a user plane (UP) connection to receive the downlink data. In some implementations, paging is DL procedure, where in the network is paging the WTRU or AIoT device to respond, and to transition the WTRU or AIoT device back to connected mode, and service request is an UL procedure triggered by the WTRU or AIoT device to transition from idle mode to connected mode. In some implementations, the WTRU is paged, e.g., by the network (e.g., by an AMF of the network) based on its intermediate temporary identifier (e.g., 5G Globally Unique Temporary Identity (5G-GUTI)). In some implementations, the WTRU is paged, e.g., by the network (e.g., by an AMF of the network), based on a shortened form of the 5G-GUTI (e.g., a 5G Serving Temporary Mobile Subscriber Identity (5G-S-TMSI)). In some implementations, the temporary identifier is assigned to the WTRU by the network (e.g., by the AMF). In some implementations, the temporary identifier is assigned to the WTRU uniquely, e.g., in the context that the WTRU would be for the entire PLMN. In some implementations, the AIoT device is pageable by the temporary identifier. In some implementations, the WTRU is pageable by the temporary identifier for all PDU Sessions of the WTRU. In some implementations, in response to the paging message, WTRU indicates all of its PDU sessions whose connection can be re-activated. In some implementations, the WTRU indicates such PDU sessions in a Service Request message. In some implementations, the network (e.g., an SMF of the network) establishes or re-establishes a UP connection for a PDU Session (e.g., in the list of PDU Sessions) for which pending DL data triggered the paging.

Some implementations include an Early Paging Indicator (EPI). In some implementations, early paging is used to reduce power consumption in the WTRU. For example, in some implementations, an EPI is sent to the WTRU (e.g., over downlink control information (DCI) or a reference signal). Based on receiving the EPI, the WTRU checks the next paging occasion (PO) for paging instead of decoding every PO sent during the waking time. In this context, decoding the paging occasion means checking the PO to see if there is paging for the WTRU. In some implementations the WTRU does not need to check each PO, but rather, based on EPI it will check the next paging occasion. In some implementations, the WTRU prepares to decode the next received PO based on receiving the EPI.

Some implementations include sub-grouping. In some implementations, an AIoT device group is divided into subgroups. In some implementations, sub-group information (e.g., an identifier which will identify whether this subgroup is applicable to this particular AIoT device) is sent with the EPI in the same DCI. In some implementations, the AIoT device may determine whether to decode the next PO based on the sub-group information. In some implementations, sub-grouping may provide the advantage of enhancing paging, e.g., by reducing the false paging notification rate. In some implementations, dividing a group of AIoT devices into subgroups may have the advantage of avoiding a large number of AIoT devices within a group having the same PO, or a large number of inactive AIoT devices within a group having the same EPI. In some implementations, this can have the advantage of reducing AIoT device power consumption.

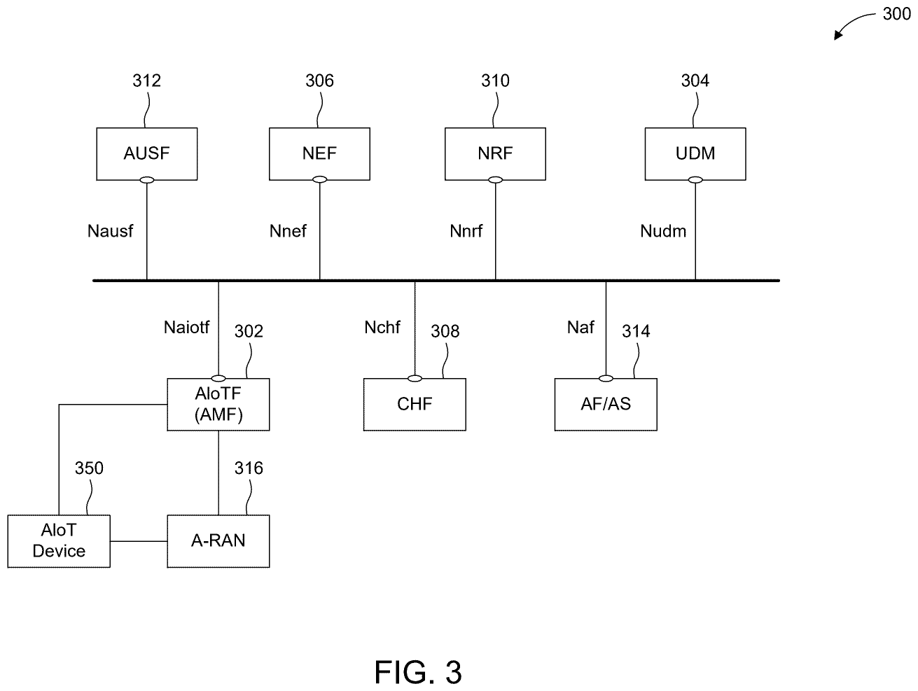

Some implementations include an 5GS architecture that is enhanced to support AIoT devices. For example, FIG. 3 is a system diagram of an example network 300. Network 300 illustrates an example enhanced 5GS architecture which supports AIoT devices and services. It is noted that in some implementations, a network architecture which supports AIoT devices includes all, some, only one, or none of the enhancements described with respect to FIG. 3, in any suitable combination. In some implementations, the architecture of FIG. 3 is usable with the system of FIG. 2.

In this example, network 300 includes an Ambient IoT Function (AIoTF) 302 and corresponding service based interface as Naiotf, Unified Data Management Function (UDM) 304 and corresponding service based interface as Nudm, Network Exposure Function (NEF) 306 and corresponding service based interface as Nnef, Charging Function (CHF) 308 and corresponding service based interface as Nchf, Network Repository Function (NRF) 310 and corresponding service based interface as Nnrf, Authentication Server Function (AUSF) 312 and corresponding service based interface as Nausf, and Application Function/Application Server Function AF/AS 314 and corresponding service based interface as Naf. In some implementations, an AIoT device 350 communicates with network 300 via AIoTF 302, either directly or via A-RAN 316.

In some implementations, the functional entities described with respect to network 300 are as per their counterparts in typical 5G system architecture (e.g., as defined in TS 23.501), but may include enhancements, such as enhancements to support AIoT devices and services. For example, the following enhancements may apply to some, all, or none of the following functional entities: UDM 304 is enhanced to store and manage AIoT device information. In some implementations, AIoT device information contains device ID, device status information (e.g. enabled/disabled/permanently disabled), and/or CN related information (e.g. serving NF) for an AIoT device that is connected to the network (e.g., AIoT device 350). NEF 306 is enhanced to expose AIoT-specific services to AF/AS 314. CHF 308 is enhanced for charging for AIoT services. NRF 310 is enhanced to support a new AIoTF network function type and its corresponding network function profile. AUSF 312 is enhanced to support authentication of accesses from AIoT devices.

AF/AS 314 may be under the control of a third party, which may trigger a paging or inventory procedure for the AIoT devices toward the core network.

AIoT device 350 are ambient power-enabled IoT devices that can harvest energy from the environment, such as wireless radio waves, motion, vibration, piezoelectricity, solar and wind power, etc.

AIoTF 302 is introduced to support AIoT services. In some implementations, some AMF functionalities are integrated with AIoTF 302, such as A-RAN (Ambient IoT RAN) connectivity, Inventory (Paging) handling and device context management, Authentication and authorization for the access, which triggers interaction with AUSF/UDM, Collection of charging data and interaction with CHF for charging, Routing the request from AF (via NEF) to A-RAN, for DO-DTT/DT traffic types and Routing the response from A-RAN to AF (via NEF) for DO-DTT traffic type.

A-RAN 316 provides connectivity between the AIoT devices and 5G network functions. In some implementations, an A-RAN may be or include a base station (gNB) or an intermediate node WTRU.

In some implementations, a paging or inventory procedure may be triggered by an AF (e.g., AF/AS 314). In some implementations inventory and paging are similar procedures (e.g., both are DL requests for an AIoT device to respond (e.g., with an identification). In some implementations, paging may not ask for additional information, whereas an inventory procedure may ask for additional information in response.) Accordingly, various examples herein described with respect to paging also apply to inventory, and various examples herein described with respect to inventory also apply to paging. In some implementations, the AF triggers the paging or inventory procedure by sending an inventory request message to the CN (e.g., CN 202, or a component thereof) and the CN (or component thereof) consequently sends a corresponding request to A-RAN (e.g., A-RAN 316), which sends a corresponding message or messages to AIoT devices with which it is in communication. In some implementations, the AIoT device or devices (e.g., AIoT Device 350, or AIoT Devices 212, 214, 216, 218, 220, 222) respond to the inventory request from A-RAN. In some implementations, the response by an AIoT device includes its device ID, and in some implementations, the response by the AIoT may include additional information (e.g., if requested via the paging/inventory/command procedure).

In some implementations, the AF may also provide inventory strategy information, e.g., in the inventory request message. In some implementations, the inventory strategy information includes, e.g., an indication of inventory frequency and/or inventory period. In some implementations, the inventory strategy information enables the CN and/or A-RAN to perform periodic inventories. In some implementations, such periodic inventories enable AIoT devices which have newly harvested enough energy to become available, to be discovered. In some implementations, the inventory strategy information enables the CN and/or A-RAN to perform periodic AIoT device inventories without further explicit requests from the AF.

In some implementations, an AIoT paging or initial trigger message can be used to trigger a single device, a group of devices using a group ID, multiple devices with separate IDs, or all devices in a coverage area to respond for inventory and/or command use cases. In some implementations, a paging message for AIoT devices can also be considered to be a type of inventory request for all devices, a group of devices or a single device.

In some implementations, a downlink AIoT paging message may be or may include a message indicating a single AIoT device; a message indicating multiple AIoT devices; a message indicating a group which includes multiple AIoT devices; and/or a message that does not indicate a specific AIoT device, specific multiple AIoT devices, or specific group of AIoT devices. In some implementations, a downlink AIoT paging message, may be or include a message including an identifier (ID) of a single AIoT device; a message indicating multiple IDs of AIoT devices; a message indicating a group ID that maps to multiple AIoT devices; and/or a message that does not indicate an ID.

In some implementations, an AIoT paging message may indicate a group by indicating a group identifier. Alternatively, the message may indicate a mask that may be mathematically combined with the AIoT device identifier in order to identify a group of devices. In some implementations, the message indicates the group in another suitable manner. In some implementations, an AIoT paging message that does not indicate an ID indicates (e.g., implicitly) a request for an inventory for all devices in a coverage area.

In some implementations, in cases where the AIoT device is mobile or in cases where the AIoT device is within overlapping coverage of multiple readers, gNBs, and/or intermediate node devices, the AIoT device may receive paging messages from multiple nodes.

In some cases, unconditional handling by AIoT devices of a paging message that targets all devices can lead to multiple issues. For example, in some cases such unconditional handling may lead to excessive signaling overload (e.g., RACH attempts) for readers (gNB/Intermediate UEs, collectively known as A-RAN). In some cases such unconditional handling may lead to battery drainage (or other energy storage drainage) for AIoT devices e.g., that are already constrained on power. In some cases such unconditional handling may lead to all-device paging being exploited by malicious actors to obtain sensitive device information (e.g., device ID, number of devices, etc.) or to perpetrate a Denial of Service (DOS) type attack. Accordingly, it may be desired to enhance 5GS infrastructure for AIoT devices, e.g., to address these or other problems. For example, it may be desired to enhance 5GS infrastructure for AIoT devices to improve or optimize handling of all-device paging messages to avoid such issues and/or facilitate operational efficiency for involved entities of the 5G mobile system.

Some implementations provide 5G system enhancements for handling the all-device paging message for AIoT devices. For example, some implementations include a paging handling configuration for the AIoT devices. In some implementations, paging handling configuration information may be pre-provisioned into AIoT devices. In some implementations, paging handling configuration information may be provided to AIoT devices by the 5GS; e.g., via an AIoT command message. In some implementations, the provisioning of paging handling configuration information may be carried out using external parameter provisioning procedure, e.g., by an AF which resides outside typical 5G network functions. In some implementations, such paging handling configuration information may be used to configure the AIoT devices with ways in which to react to all-device paging. For example, in some implementations, such paging handling configuration information may be used to configure the AIoT devices to respond to the all-device paging, to respond to the all-device paging with an alternate device ID (i.e., not revealing its true device ID) or to respond to the all-device paging with the true Device ID. In some implementations, a no-response time period may be indicated to AIoT devices (e.g., in the paging handling configuration information or in another suitable way). In some implementations, the no-response time period may indicate a time following a response by the AIoT device to paging (e.g., all-device paging) during which the AIoT device will not respond to further all-device paging requests. In some implementations, the time period is tracked using a timer (e.g., a “no-response timer”).

Some implementations provide handling of Paging, Initial Trigger, and/or Inventory messages, and Paging Configuration for AIoT devices.

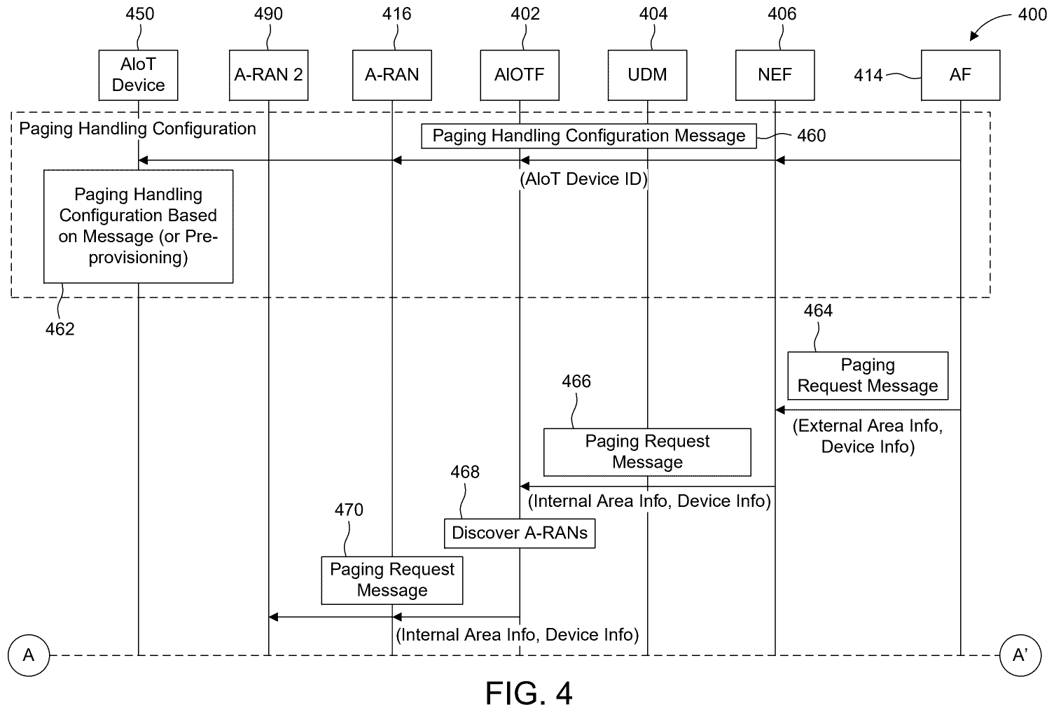

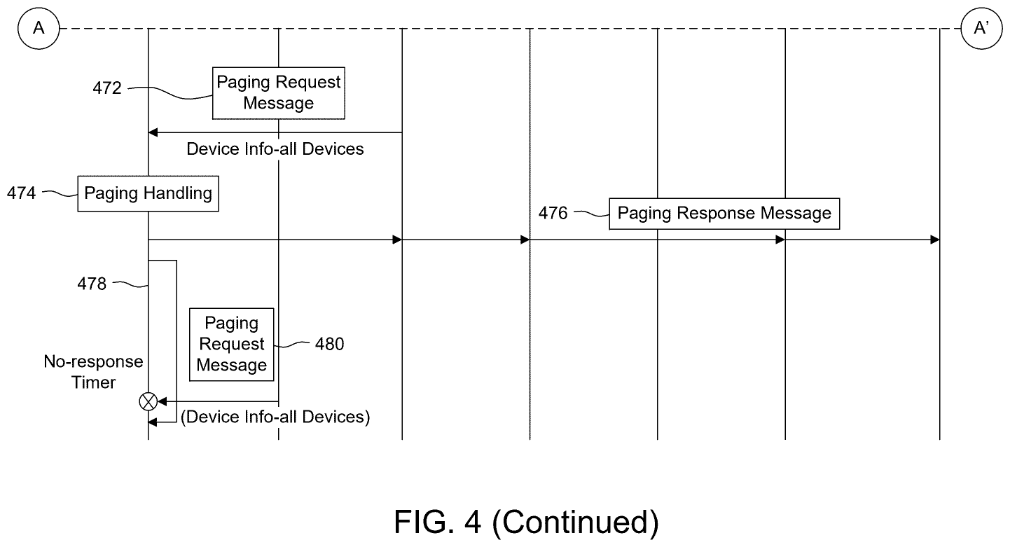

FIG. 4 is a message sequence chart illustrating an example procedure 400 for paging AIoT devices, and for configuring AIoT devices for paging. In some implementations, procedure 400 is usable with architecture 300 as shown and described with respect to FIG. 3, and/or with network 200 as shown and described with respect to FIG. 2. Procedure 400 describes example communications and functions among several devices and functions of a network that is enhanced to support AIoT devices, such as AIoT device 450, and includes an AIOTF 402, UDM 404, NEF 406, and AF 414. AIoT device 450 communicates with other aspects of the network via AIoTF 402 via A-RAN 416 and A-RAN2 490.

In this example, AIOTF 402, UDM 404, NEF 406, AF 414, AIoT device 450, AIoTF 402, and A-RAN 416 correspond substantially to AIOTF 302, UDM 304, NEF 306, AF 314, AIoT device 350, AIoTF 302, and A-RAN 316 as shown and described with respect to FIG. 3. The network whose operation is described by procedure 400 also includes a second A-RAN (A-RAN2 490), which is also within communications range of AIoT device 450. It is noted that in some implementations, the network may include devices and/or functions (such as devices and/or functions corresponding to CHF 308, NRF 310, and/or AUSF 312 as shown and described with respect to FIG. 3) other than those described with respect to procedure 400, and/or some or all of such functions and/or devices may be combined and/or omitted in any suitable manner.

Some aspects of procedure 400 relate to the configuration of AIoT device 450 to handle paging. In this example, paging handling configuration information is either preconfigured (e.g., pre-provisioned by the network or pre-programmed into AIoT device 450) or is received by AIoT device 450. In some implementations, AIoT device 450 receives the paging handling configuration information in a command (e.g., paging handling configuration command 460) from the network. In the example of procedure 400, AF 414 transmits a paging handling configuration command 460 to AIoT device 450, and AIoT device 450 performs paging handling configuration 462 based on the paging handling configuration command 460. In some implementations, paging handling configuration command 460 is received from AF 414 via NEF 406, AIoTF 402 and A-RAN 416. In some implementations, paging handling configuration command 460 is received from the network in any other suitable manner, from any other suitable device and/or function.

In some implementations, a device ID is pre-provisioned to the AIoT device 450. In some implementations, a device ID is provided to the AIoT device 450 along with (or as a part of) the paging handling configuration information that is pre-provisioned. In some implementations, Paging Handling Configuration Command 460 is addressed to the AIoT device 450 by its device ID. In some implementations, paging handling configuration 462 includes verification and/or storage of the paging configuration information. In some implementations, verification of the paging handling information includes checking that the device ID indicated in the Paging Handling Configuration command 460 matches or otherwise corresponds to the device ID of the AIoT device 450 (e.g., as pre-provisioned to AIoT device 450 or provided to AIoT device 450 in another manner.) In some implementations, AIoT device 450 stores the paging configuration information. In some implementations, AIoT device 450 overwrites previously stored information (e.g., previously stored paging configuration information) with the paging configuration information. In some implementations, an indication of the paging handling configuration information, rather than the configuration information itself, is received in pre-configuration or in Paging Handling Configuration command 460 (e.g., as an index to a table of paging configuration information, or a memory address or pointer to stored paging configuration information, etc.)

In some implementations, the paging handling configuration information is, includes, and/or indicates “all-device” configuration information; i.e., information for configuring AIoT device 450 to respond to all-device paging. Such information may include information for configuring AIoT device 450 to respond to all-device paging according to one or more of the following behaviors, and/or other behaviors: not to respond to all-device paging; to respond to all-device paging with an alternate device ID (and not to reveal the true device ID); to respond to the all-device paging without any special handling (e.g., the AIoT device responds with the true Device ID); to respond to the all-device paging based on a no-response time period configuration (e.g., only to respond after a configured time duration has passed since the last all-device paging request; to respond to all-device paging based on location (e.g., only to respond if the AIoT device is in a certain location or locations, or within certain boundaries, etc., e.g., based on valid locations information); not to respond to the all-device paging if a stored power level of the AIoT device is below a threshold stored power level; and/or to respond to all-device paging if the entity requesting all-device paging is authorized to send such request type to the AIoT device (e.g., if the entity is on a list of readers authorized for all-device paging).

In some implementations, “true device ID” refers to an actual AIoT device identifier assigned to the AIoT device, e.g. by an operator or 3^{rd} party credentials holder, or otherwise). In some implementations, an alternate device ID may be a device identifier other than a true device ID. In some implementations, an alternate device ID may be based on any suitable algorithm (e.g., public-key cryptography). For example, in some implementations the AIoT device (or other device) may generate an alternate device ID based on a pre-configured algorithm (e.g., public-key cryptography).

In one example, an All-Device Paging Handling Configuration may indicate that the AIoT device should not respond to a paging message that is directed to all devices (or all AIoT devices). Throughout, paging that is directed to all devices refers to either paging to all devices, or paging to all AIoT devices, in different embodiments. In another example, an All-Device Paging Handling Configuration may indicate that the AIoT device should respond to a paging message that is directed to all devices and that any response should include an alternate device ID. In another example, an All-Device Paging Handling Configuration may indicate that the AIoT device should respond to a paging message that is directed to all devices and that such response may include the true identity of the AIoT device.

In another example, an All-Device Paging Handling Configuration may indicate that the AIoT device should respond to a paging message that is directed to all devices only if the AIoT device receives the message while in certain locations. In some implementations, such All-Device Paging Handling Configuration may indicate in which locations the AIoT device is expected to respond. In another example, an All-Device Paging Handling Configuration may indicate that the AIoT device should NOT respond to a paging message that is directed to all devices if the AIoT device receives the message while in certain locations. The All-Device Paging Handling Configuration can indicate in which locations the AIoT device is not supposed to respond.

In another example, an All-Device Paging Handling Configuration may indicate that the AIoT device should not respond to a paging message that is directed to all devices if the energy that is available to the AIoT device is below a threshold. In some implementations, energy being available to the AIoT device refers to energy that is stored in a battery, energy that is stored in a capacitor, or energy that can be harvested.

In another example, an All-Device Paging Handling Configuration may indicate that the AIoT device should respond to a paging message that is directed to all devices only if the AIoT device receives the message from certain readers. In some implementations, such All-Device Paging Handling Configuration may indicate which readers a paging message may trigger the AIoT device to respond. In another example, an All-Device Paging Handling Configuration may indicate that the AIoT device should not respond to a paging message that is directed to all devices if the AIoT device receives the message from certain readers. In some implementations, such All-Device Paging Handling Configuration may indicate from which readers a paging message may not trigger the AIoT device to respond.

In another example, an All-Device Paging Handling Configuration may include a no-response time value. In some implementations, such no-response time value may indicate how long the AIoT device should ignore paging messages after responding to a paging message that is directed to all devices. In some implementations, the AIoT device may track this no-response time using a timer, or in another manner. Alternatively, in some implementations the no-response time may indicate how long the AIoT device should ignore paging messages that are similar to paging message that already triggered the AIoT device to respond. In some implementations, paging messages may be considered to be similar if they indicate the same AIoT device and/or group identifiers. In some implementations, the AIoT device may be configured to consider paging messages to be similar only if the paging messages are received from different readers.

The examples above describe how the All-Device Paging Handling Configuration information may be used to configure the AIoT device to determine how and whether to respond to a paging message that targets all devices. However, it is noted that the same concepts may be used to configure the AIoT device to determine how and whether to respond to paging messages that target multiple devices (e.g., a paging message that targets a specific group of devices, e.g., by a group ID).

In some implementations, two or more paging requests may be considered to be the same, or similar, if they include some of the same information. For example, a first paging request may indicate that it was sent by a first reader and that all devices are requested to respond, and second paging request may indicate that it was sent by a second reader and that all devices are requested to respond. Since the first and second paging messages request that the same devices respond, the first and second paging messages may be considered to be the same in this example, even though they are from different readers (e.g., from a first reader implementing A-RAN 416 and from a second reader implementing A-RAN2 490).

In another example, a first paging request may indicate that it was sent by a first reader and that a specific device or devices are requested to respond. A second paging request may indicate that it was sent by a second reader and that the same specific device or devices are requested to respond. Since the first and second paging messages request that the same device or devices respond, the first and second paging messages may be considered to be the same in this example, even though they are from different readers.

In another example, a first paging request may indicate that it was sent by a first reader and that a specific group or groups of devices are requested to respond. A second paging request may indicate that it was sent by a second reader and that the same specific group or groups of devices are requested to respond. Since the first and second paging messages request that the same devices respond, the first and second paging messages may be considered to be the same in this example, even though they are from different readers.

Some aspects of procedure 400 relate to the handling of paging by AIoT device 450, based on its paging handling configuration. In this example, AF 414 sends a paging request message 464 to NEF 406. In some implementations, the paging request message 464 is a paging request message in this example, however it is noted that in some implementations the request message(s) may include an inventory, command, and/or paging message request. In some implementations, paging request message 464 includes area information (e.g., geographical area information) and/or device information. In some implementations, the area information indicates an area in which devices should be paged. In some implementations, the device information may be, include, and/or indicate a device ID, multiple device IDs, a device group ID, and/or an indication that all devices should be paged. In some implementations, the device information is sent separately from (e.g., alongside) the paging request message 464.

Based on paging request message 464, NEF 406 may authorize the request from AF 414, and may translate the area information provided by the AF 414 into an internal area (e.g., TAIs and/or Cell IDs). In some implementations, based on the internal area information, NEF 406 may determine which AIoTFs serve this area. In some implementations, NEF 406 sends a paging request message 466 (which may have the same content as paging request message 464) to the determined AIoTFs (AIoTF 402 in this example). In other words, NEF 406 determines which AIoTFs can be used to communicate in the area that is defined by the area information. In some implementations, NEF 406 also sends an indication of the internal area information and/or device information to AIoTF 402. In some implementations, NEF 406 sends the indication of the internal area information and/or device information to AIoTF 402 in paging request message 466, or separately from (e.g., alongside) the paging request message 466. In some implementations, the device information may indicate a device ID, multiple device IDs, a device group ID, and/or an indication that all devices should be paged.

Based on paging request message 466, AIoTF 402 performs discovery 468 and discovers A-RANs, e.g., based on the internal area information provided by NEF 406. In some implementations, discovery of A-RANs includes determining which A-RANs can be used to communicate in the area indicated by NEF 406 (i.e., where AIoT devices intended for paging are located).

Based on discovery 468, AIoTF 402 sends a paging request message 470 (which may have the same content as paging request message 464) to the discovered A-RANs. In this example, AIoTF 402 sends paging request message 470 to A-RAN 416 and A-RAN2 490 based on discovery 468. In some implementations paging request message 470 is sent as a Next Generation Application Protocol (NGAP) message.

In some implementations, AIoTF 402 also sends an indication of the internal area information and/or device information to A-RAN 416 and A-RAN2 490. In some implementations, AIoTF 402 sends the indication of the internal area information and/or device information to A-RAN 416 and A-RAN2 490 in paging request message 470, or separately from (e.g., alongside) the paging request message 470. In some implementations, the device information may indicate a device ID, multiple device IDs, a device group ID, and/or an indication that all devices should be paged.

After receiving paging request message 470, A-RAN 416 (reader) initiates paging based on paging request message 470 and the device information received from AIoTF 402. It is noted that as used herein, reader is a generic term for a device which can establish radio communication with AIoT devices. It is noted that A-RAN 416 is a reader and may be a gNB or intermediate node WTRU. In this example, A-RAN 416 transmits paging request message 472 (which may have the same content as paging request message 464) based on request message 470. In some implementations, paging request message 472 may include an indication that the paging message target one, or several AIoT devices (e.g., single, multiple, group, area, etc. ‘as discussed herein). For example, in some implementations the paging message may include a group ID that indicates that the paging message targets all AIoT devices in a group of AIoT devices. In some implementations, the paging message may include an identifier and a mask to indicate that the paging message targets all devices whose device identifier matches at least part of the identifier that is in the paging message. Any other suitable indication is also possible in other implementations.

After AIoT device 450 receives paging request message 472 from A-RAN 416, in some implementations, AIoT device 450 responds or does not respond to the paging based on its paging configuration (e.g., which may be stored locally within the AIoT device). In some implementations, AIoT device 450 determines whether to respond based on its paging configuration and paging request message 472.

In some implementations, depending on the behavior indicated by its paging configuration, AIoT device 450 may respond to the paging with an alternate identifier, may respond to the paging with its true identifier, may make no response at all to the paging, or may respond with either the true or alternate identifier and not respond to any further paging request messages (and/or other such paging and/or inventory messages, or in some implementations, specifically those paging messages which indicate all-device paging, or in some implementations, which indicate some other specific type of paging)) from the A-RAN 416 (or, in some implementations, from any reader, such as A-RAN 490) for a no-response time after receiving paging request message 472.

In some implementations, AIoT device 450 tracks the no-response time based on a no-response timer (e.g., by starting a no-response timer—in other words, while the no-response timer is running AIoT device 450 would not respond to any further paging request messages (and/or other such paging and/or inventory messages). In some implementations, while the no-response timer is running AIoT device 450 would not respond to any further paging request messages (and/or other such paging and/or inventory messages) from the reader with a specific paging type (or types), such as all-devices type paging commands. In some implementations, paging type refers to the content of the paging message, for example the paging type could be a paging message containing an ID of a single AIoT device, or a paging message containing multiple IDs of AIoT devices, or a paging message containing a group ID that maps to multiple AIoT devices. This group ID may be identified by a group identifier. Alternatively, the paging message may contain a mask that can be mathematically combined with the AIoT device identifier in order to identify a group of devices or a paging message that does not contain an ID, i.e., inventory for all devices in the coverage area. In some implementations the no-response time is tracked in a manner other than using a timer. In some implementations, the paging type comprises all-device type (e.g., where all AIoT devices are paged), single AIoT type (e.g., where a single particular AIoT device is paged to respond), multiple AIoT type (e.g., where multiple identified AIoT devices are paged to respond), and/or AIoT group type (e.g., where an identified group of AIoT devices is paged to respond).

AIoT device 450 transmits a paging response message 476 responsive to the received paging request message 472 and based on paging handling 474. In some implementations, AIoT device 450 starts a no-response time 478 after sending paging response message 476. In some implementations, paging response message 476 is communicated to AF 414 via A-RAN 416, AIoTF 402, and NEF 406. In some implementations, paging response message 476 indicates inventory information. In some implementations, paging response message 476 indicates an ID of AIoT device 450. In some implementations, the network is made aware of the inventory of AIoT devices 450 based on receiving the ID of AIoT device 450. In this context, being aware of the inventory of AIoT device 450 means that the network is aware of the presence and/or number of AIoT devices 450 in the network. In some implementations, paging response message 476 also indicates application specific data, such as state information of AIoT device 450, a sensor reading, and/or any other suitable information.

A-RAN2 490 (reader) initiates paging (or inventory, or command) based on paging request message 470 and the device information received from AIoTF 402. In this example, A-RAN2 490 transmits a paging request message 480 based on request message 470. Paging request message 480 includes an indication that the paging message targets all devices (e.g., by including a group ID, or an identifier and a mask as discussed further herein, etc.)

In this example, paging request message 480 is received by AIoT device 450 during no-response time 478. Accordingly, based on no-response time 478, AIoT device 450 does not respond to paging request message 480. In some implementations, this prevents AIoT device 450 from responding to the same paging request received from different readers (e.g., both paging request message 472 from A-RAN 416 and paging request message 480 from A-RAN2 490 in this example). In some implementations, this may have the advantage of avoiding excessive traffic and/or needlessly draining energy from AIoT device 450.

In some implementations, if a paging request message 480 had been received after no-response time 478 (or otherwise when no-response time 478 is not running), AIoT Device 450 would have responded based on paging handling 474 and paging request message 480, similar to the response to the received paging request message 472 described above.

Some implementations involve avoiding simultaneous responses to paging and/or stopping responses to paging. For example, as shown and described with respect to FIG. 4, in some implementations an AIoT Device (e.g., AIoT device 450 may respond to a paging request (e.g., paging request message 472) by either responding, or not responding. In the example of procedure 400, AIoT device 450 responds to paging request message 472 with paging response 476, based on paging handling 474. In some implementations, the AIoT determines whether to respond to a paging request, e.g., based on its paging handling configuration (e.g., paging handling configuration 462). In some implementations, the AIoT determines whether to respond to a paging request in some other way.

In some implementations, an AIoT device may wait for a “no-response” time (e.g., using a delay timer, or tracking the no-response time in another manner) after responding to a paging request before the AIoT device responds to any further paging requests. In some implementations, the AIoT device waits for the no-response time after determining whether to respond before the AIoT device responds to any further paging requests.

In the example of procedure 400, AIoT device 450 waits for no-response time 478 after sending paging response message 476 before it will respond to any further paging requests, and accordingly, does not respond to Paging Request message 480, which arrives during no-response time 478.

In some implementations, a no-response time applies only to certain paging messages. For example, in some implementations, an AIoT device will send a response to a paging message that arrives during a no-response time based on an indication that paging responses are still needed regardless of the no-response time. In some implementations, the indication may be separate from the paging message.

In some implementations, the no-response time, or a value that is used to determine the no-response time, may be configured in the AIoT device in the paging handling configuration (e.g., paging handling configuration 462).

In some implementations, using value that is used to determine the no-response time can have the advantage of facilitating different AIoT Devices in determining different no-response times, e.g., to avoid a situation where many devices simultaneously respond to paging.

In some implementations, during the no-response time, the AIoT Device checks whether the paging message is still being transmitted by the network and/or whether the network is transmitting an indication (either part of the paging message, or that is separate from the paging message) that indicates that page responses are still needed. In some implementations, the AIoT may determine whether to respond to the paging message during the no-response time based on the paging message and/or the indication. In some implementations, this may have the advantage of facilitating the network in indicating whether enough devices have already responded to the paging message, allowing the AIoT device to determine whether it can avoid responding and thus save energy and network spectrum resources. In some implementations, this may have the advantage of facilitating the network in indicating whether not enough AIoT devices have responded to the paging message, overriding the no-response timer in this circumstance.

The following describes an example implementation which includes actions taken by an AIoT device in response to a paging request message, including various options. In this example, an AIoT Device is configured with configuration information for handling all-device paging, and with a no-response time value. In some implementations the configuration information may indicate that the AIoT Device should respond to a paging message that is directed to all devices only if the device receives the paging message while in certain locations. In some implementations the configuration information may indicate that the AIoT Device should respond to a paging message that is directed to all devices only if the device receives the paging message from certain readers. In this example, an AIoT Device receives a first paging message from a first reader. The message indicates that the paging message is directed to more than one device. The AIoT Device sends a response message. The response message includes an identifier of the AIoT device. The AIoT device uses its all-device paging handling configuration information to determine what identifier of the device to include in the response message. In some implementations, the response is only sent if the AIoT Device determines that the location of the AIoT device matches the location information that is in the paging handling configuration information. In some implementations, the response is only sent if the AIoT device determines that the paging message was sent from a reader whose identity was indicated by the paging handling configuration information. In some implementations, sending the response message triggers the AIoT Device to start a no-response time (e.g., using a timer, or other method) and the duration of the no response time is configured based on the no-response timer value.

In the example, the AIoT Device receives a second paging message from a second reader. The second paging message includes the same information as the first paging message (i.e. all device paging). Based on the no-response time having not expired, the AIoT Device determines to not respond to the second paging message (e.g., ignores the second paging message). After the no-response timer having expired, the AIoT Device sends a second response message and restarts the no-response time. Duration of the no response timer is again configured based on the no-response timer value.

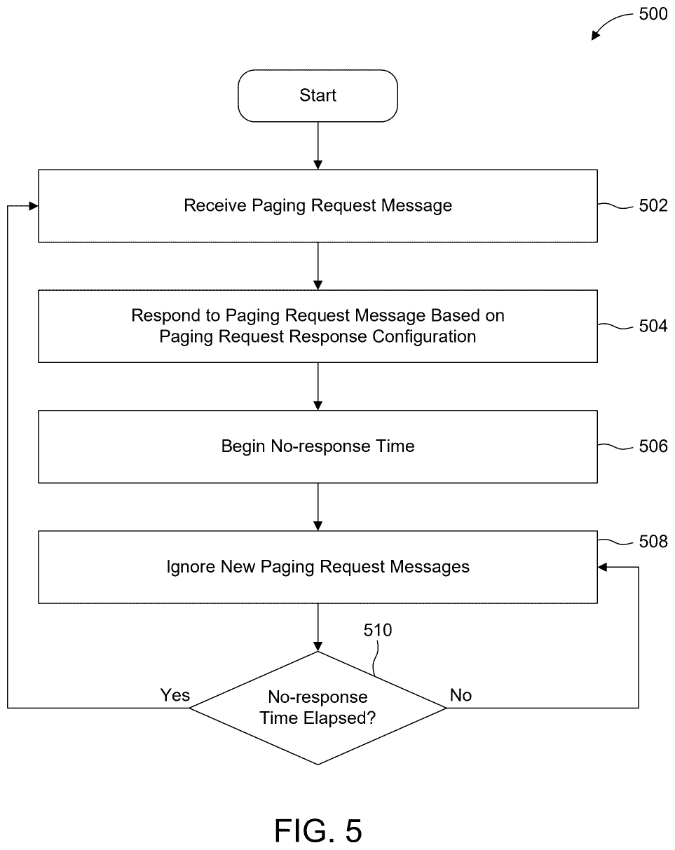

FIG. 5 is a flow chart which illustrates an example method 500, implemented in an AIoT device, for handling a paging request message. Method 500 is usable, for example, with procedure 400 as shown and described with respect to FIG. 4, and/or with architecture 300 as shown and described with respect to FIG. 3, and/or with network 200 as shown and described with respect to FIG. 2

In 502, the AIoT device receives a paging request message. The paging request message may be any paging request message as described herein. For example, in some implementations, the paging request message is an all-device paging message, requesting paging responses from all recipient AIoT devices.

In 504, the AIoT device responds to the paging request message based on its configuration for responding to paging request messages. The responds may be any suitable response as described herein. For example, in some implementations, the AIoT device may respond to the paging request message with an alternative device ID, based on its configuration for responding to paging request messages for responding to all-device paging messages.

In 506, the AIoT device begins a no-response time. The no-response time may be as described herein. For example, in some implementations, the no-response time is based on the configuration for responding to paging request messages.

In 508, the AIoT device ignores new paging request messages, e.g., according to the configuration for responding to paging request messages. This may be as described herein. For example, in some implementations the AIoT device may ignore all new paging request messages, or may ignore only all-device paging request messages, or paging request messages from the same reader/A-RAN, etc.

On condition 510 that the no-response time has elapsed, the AIoT device resumes receiving and responding to paging request messages at 502. Otherwise, the AIoT device continues to ignore new paging request messages at 508.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented in an ambient powered internet-of-things (AIoT) device, the method comprising:
receiving a paging request message;
transmitting a response to the paging request message based on a paging response configuration; and
starting a no-response time based on responding to the paging request message;
wherein the no-response time is started when the paging request message is received, or when the response to the paging request message is transmitted.

2. The method of claim 1, wherein the AIoT device ignores further paging request messages until the no-response time has elapsed.

3. The method of claim 1, wherein the AIoT device ignores further paging request messages that are of a particular type and does not ignore further paging requests that are not of the particular type, until the no-response time has elapsed, wherein the type comprises all-device type, single AIoT type, multiple AIoT type, and/or AIoT group type.

4. The method of claim 1, wherein the AIoT device ignores further all-device paging request messages and does not ignore further paging requests that are not all-device paging request messages, until the no-response time has elapsed.

5. The method of claim 1, wherein the AIoT device ignores further paging request messages of a same type as the received paging request message and does not ignore further paging requests that are not of the same type as the received paging request message, until the no-response time has elapsed, wherein the type comprises all-device type, single AIoT type, multiple AIoT type, and/or AIoT group type.

6. The method of claim 1, wherein the AIoT device ignores further paging request messages from a same sender from whom the received paging request message was received and does not ignore further paging requests that are not from the same sender, until the no-response time has elapsed.

7. The method of claim 1, wherein the AIoT device ignores further paging request messages that include a same mask identifying a group of AIoT devices as the received paging request message and does not ignore further paging requests that do not include the same mask identifying the group of AIoT devices, until the no-response time has elapsed.

8. The method of claim 1, wherein the response to the paging request message comprises a device identity (ID) of the AIoT device.

9. The method of claim 8, wherein the device ID comprises a true device ID of the AIoT device or an alternate device ID of the AIoT device, based on the paging response configuration.

10. The method of claim 9, wherein the AIoT device generates the alternate device ID based on an algorithm indicated by the paging response configuration.

11. An ambient powered internet-of-things (AIoT) device comprising:
circuitry configured to receive a paging request message;
circuitry configured to transmit a response to the paging request message based on a paging response configuration; and
starting a no-response time based on responding to the paging request message;
wherein the no-response time is started when the paging request message is received, or when the response to the paging request message is transmitted.

12. The AIoT device of claim 11, further comprising circuitry configured to ignore further paging request messages until the no-response time has elapsed.

13. The AIoT device of claim 11 further comprising circuitry configured to ignore further paging request messages that are of a particular type and does not ignore further paging requests that are not of the particular type, until the no-response time has elapsed, wherein the type comprises all-device type, single AIoT type, multiple AIoT type, and/or AIoT group type.

14. The AIoT device of claim 11 further comprising circuitry configured to ignore further all-device paging request messages and does not ignore further paging requests that are not all-device paging request messages, until the no-response time has elapsed.

15. The AIoT device of claim 11 further comprising circuitry configured to ignore further paging request messages of a same type as the received paging request message and does not ignore further paging requests that are not of the same type as the received paging request message, until the no-response time has elapsed, wherein the type comprises all-device type, single AIoT type, multiple AIoT type, and/or AIoT group type.

16. The AIoT device of claim 11 further comprising circuitry configured to ignore further paging request messages from a same sender from whom the received paging request message was received and does not ignore further paging requests that are not from the same sender, until the no-response time has elapsed.

17. The AIoT device of claim 11, further comprising circuitry configured to ignore further paging request messages that include a same mask identifying a group of AIoT devices as the received paging request message and does not ignore further paging requests that do not include the same mask identifying the group of AIoT devices, until the no-response time has elapsed.

18. The AIoT device of claim 11, wherein the response to the paging request message comprises a device identity (ID) of the AIoT device.

19. The AIoT device of claim 18, wherein the device ID comprises a true device ID of the AIoT device or an alternate device ID of the AIoT device, based on the paging response configuration.

20. The AIoT device of claim 19, wherein the AIoT device generates the alternate device ID based on an algorithm indicated by the paging response configuration.
